(19) United States
(12) Patent Application Publication
(10) Pub. No.: US 2010/0245102 A1
(43) Pub. Date: Sep. 30, 2010

(54) INFORMATION DISPLAY DEVICE

(75) Inventor: Tatsuro YOKOI, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/719,368

(22) Filed: Mar. 8, 2010

(30) Foreign Application Priority Data
Mar. 31, 2009 (JP) 2009--086601

(51) Int. Cl. G08B 21/00

(52) U.S. Cl. 340/636.16

(57) ABSTRACT

An information display device, after detecting the completion of charging of a battery, counts the number of times that display content of a nonvolatile display part is rewritten. Based on the number of times of rewriting processing, the information display device derives information on a remaining battery capacity of the battery. The information display device displays the derived information on the remaining battery capacity.

### CROSS-REFERENCE TO RELATED APPLICATIONS

This application is based on and claims the benefit of priority from Japanese Patent Application No. 2009-086601 filed on Mar. 31, 2009, the entire contents of which are incorporated herein by reference.

### BACKGROUND

1. Field

The present invention relates to an information display device, and more particularly to an information display device which accurately displays a remaining battery capacity.

2. Description of the Related Art

There has been known an information display device which uses a nonvolatile display part such as an electrophoresis display panel.

In the information display device, page data contained in a data file such as an electronic book stored in a memory part is read in a page unit thus rewriting page data to be displayed on the nonvolatile display part. Accordingly, a user can read a data file such as an electronic book by operating the information display device as if the user turns over a page of an actual book.

For allowing a user to use the information display device for a long time at any place, the information display device incorporates a rechargeable battery (so-called secondary battery) as a power source. To inform the user of a remaining battery capacity of the rechargeable battery, the information display device performs a remaining battery capacity display in the same manner as a mobile phone which also uses the rechargeable battery. That is, this information display device performs a remaining battery capacity display by displaying a battery meter in which a plurality of partition zones are formed in a rectangular pattern which imitates the battery and by changing the number of displaying zones corresponding to the remaining battery capacity in stages. The information display device calculates the remaining battery capacity based on a battery voltage.

However, to focus on a change of a battery voltage, the battery voltage is gently decreased compared to the decrease of the remaining battery capacity. Accordingly, it is difficult to accurately grasp the remaining battery capacity by such a conventional method which calculates the remaining battery capacity based on the measured battery voltage and hence, the remaining battery capacity is not always accurate. Under such circumstances, it is difficult for the user to accurately grasp the number of pages which he can read. Accordingly, there exists a possibility that the user carries the information display device even when he cannot read all pages due to a shortage of remaining battery capacity. To avoid such a drawback, the user has to always carry the information display device after fully charging the battery thus preventing the comfortable use of the information display device by the user.

The present invention has been made in view of the above-mentioned drawbacks, and it is an object of the present invention to provide an information display device which can perform a remaining battery capacity display which allows a user to accurately grasp a remaining battery capacity.

According to one aspect of the present invention, there is provided an information display device which includes a nonvolatile display part, a display processing part, a charging part, a charging completion detection part, a rewriting-number-of-times counting part, a remaining battery capacity deriving part, and a remaining battery capacity display processing part. The nonvolatile display part is a display part which maintains a display even when the supply of electricity from a power source is cut. The display processing part executes rewriting processing of a display content displayed on the nonvolatile display part. The charging part charges a battery which is used as the power source. The charging completion detection part detects the completion of charging of the battery by the charging part. The rewriting-number-of-times counting part counts the number of times of the rewriting processing executed by the display processing part after the completion of charging of the battery is detected by the charging completion detection part. The remaining battery capacity deriving part derives information on a remaining battery capacity of a battery based on the number of times of rewriting processing. The remaining battery capacity display processing part executes display processing of the information on the remaining battery capacity derived by the remaining battery capacity deriving part.

### BRIEF DESCRIPTION OF THE DRAWINGS

FIG. 1 is an explanatory view showing the appearance of an information display device according to one embodiment of the present invention;

FIG. 2A to FIG. 2D are explanatory views showing a display mode of an electronic book on a nonvolatile display part of the information display device;

FIG. 3A and FIG. 3B are explanatory views showing a mode of remaining battery capacity display on the nonvolatile display part of the information display device;

FIG. 4 is a block diagram showing the electrical constitution of the information display device;

FIG. 5A and FIG. 5B are flowcharts showing a flow of rewritable-number-of-times calculation processing executed in the information display device;

FIG. 6A and FIG. 6B are flowcharts showing a flow of rewritable-number-of-times calculation processing executed in the information display device;

FIG. 7A and FIG. 7B are flowcharts showing a flow of non-charging initial setting processing executed in the information display device;

FIG. 8 is a flowchart showing a flow of sleep-mode-time accumulation processing executed in the information display device;

FIG. 9A and FIG. 9B are flowcharts showing a flow of rewritable-number-of-times recalculation processing executed in the information display device;

FIG. 10A to FIG. 10E are explanatory views showing various data stored in the information display device;

FIG. 11 is an explanatory view showing various data stored in the information display device;

FIG. 12 is a graph showing a discharge load characteristic of a rechargeable battery used in the information display device;

FIG. 13 is a graph showing a discharge load characteristic of a rechargeable battery used in the information display device; and

FIG. 14 is a graph showing a charge/discharge cycle characteristic of a rechargeable battery used in the information display device.

### DETAILED DESCRIPTION

Hereinafter, an embodiment of the present invention is explained in conjunction with attached drawings.

### [1. Summary of Information Display Device]

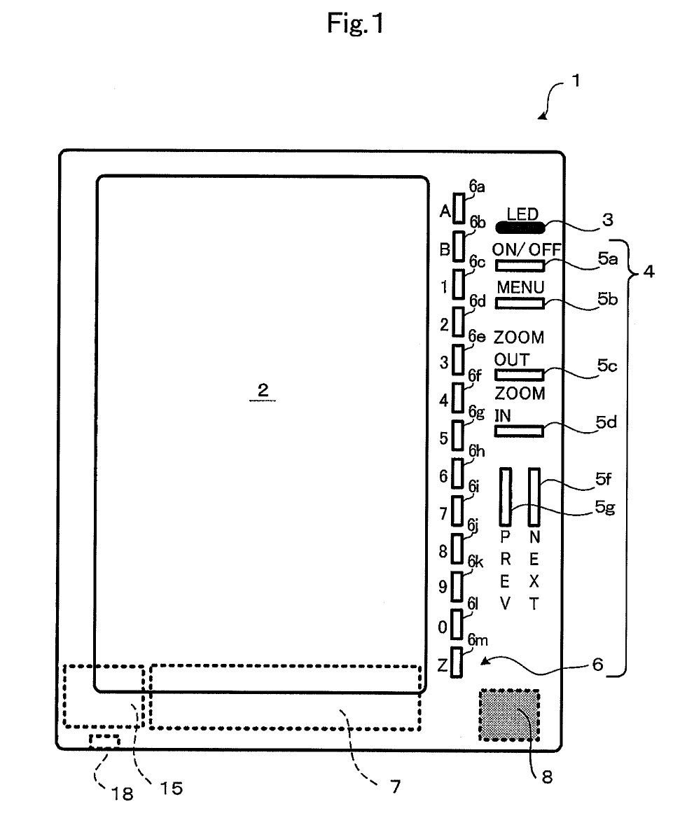

Firstly, the appearance and main operations of an information display device 1 according to this embodiment are explained in conjunction with FIG. 1 to FIG. 3.

The information display device 1 is a thin device having a rectangular shape in a plan view. The information display device 1 includes, as shown in FIG. 1, a nonvolatile display part 2 having a size of approximately A4 (JIS) on a front surface thereof. The nonvolatile display part 2 has a characteristic that even when the supply of electricity to the nonvolatile display part 2 is cut, the nonvolatile display part 2 can maintain a display.

In this embodiment, the explanation is made hereinafter assuming that the nonvolatile display part 2 is an electrophoresis display panel which can perform a display by generating an electrophoresis of charged particles dispersed in a predetermined dispersion medium. However, the nonvolatile display part 2 is not limited to the electrophoresis display panel. That is, as the nonvolatile display part 2, any nonvolatile display panel which can maintain the display even when the supply of electricity is cut can be used in this embodiment. For example, this embodiment may adopt a display panel which includes an optical anisotropic display element (using cholesteric liquid crystal, ferroelectric liquid crystal or the like), a display panel which includes a particle-rotation-type display element, a display panel which includes a particle-transfer-type display element or the like.

A battery 7 which constitutes a rechargeable secondary battery and a power source control part 15 which is provided for charging the battery 7 are incorporated into a lower portion of the information display device 1. An external connection terminal 18 to which an AC adapter or the like is connected for supplying electricity to the power source control part 15 from the outside is provided below the power source control part 15. The power source control part 15 possesses a plurality of functions. That is, the power source control part 15 functions as a charging part for charging the battery 7, a charging completion detection part which detects the completion of charging of the battery 7, and a battery voltage detection part which detects a voltage of the battery 7.

As the battery 7 which is the rechargeable secondary battery, for example, a NiCd battery (nickel cadmium battery), a nickel hydrogen battery, a lithium ion battery or the like can be used. In this embodiment, the lithium ion battery which exhibits a relatively large charging capacity relative to weight compared to other batteries and possesses a stable discharge load characteristic is used as the battery 7.

On a right side of the nonvolatile display part 2, an LED 3 which indicates a state of the information display device 1 and operation buttons 4 are arranged. The operation buttons 4 include a power source button 5a, a menu button 5b, a zoom-out button 5c, a zoom-in button 5d, a next-page turning button 5f, a previous-page turning button 5g, and selection buttons 6 (6a to 6m).

A user of the information display device 1 can perform selection, display and the like of a data file such as an electronic book displayed on the nonvolatile display part 2 by operating the operation buttons 4. As the data file such as an electronic book which can be processed by the information display device 1, a data file for displaying a document constituted of characters, figures and the like (hereinafter referred to as “document file”), a data file for displaying a graphic image such as photograph, CG or the like is named. However, the data file which can be processed by the information display device 1 is not limited to such data files. The explanation is made hereinafter, for the sake of brevity, by taking a case where the document file is used as the data file as an example. Further, the document file contains page data corresponding to the number of pages using the data displayed on the nonvolatile display part 2 as the data in a page unit.

A memory card I/F 16 which is described later is provided to a right side surface of the information display device 1, and a memory card 8 is connectable with the memory card I/F 16. The memory card 8 is a rewritable storage medium which is constituted of a nonvolatile semiconductor memory whose data is not erased even when the supply of electricity to the information display device 1 is cut. Document files corresponding to a plurality of electronic books are stored in the memory card 8. The information display device 1 reads the document file corresponding to an arbitrary electronic book selected by a user from the document files corresponding to the plurality of electronic books stored in the memory card 8 via the memory card I/F 16. The information display device 1 displays the page data contained in the document file read in this manner on the nonvolatile display part 2 thus allowing the user to read the page data.

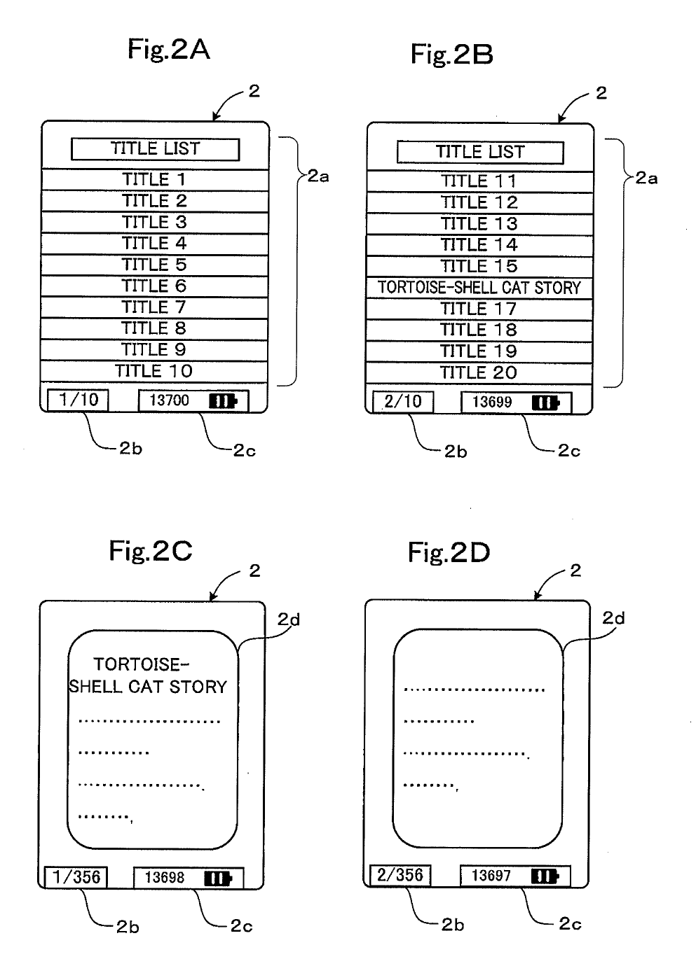

A series of operations which a user performs from a manipulation of the operation button 4 so as to select an arbitrary document file from a plurality of document files stored in the memory card 8 to a display of the selected document file on the nonvolatile display part 2 is explained hereafter in conjunction with FIG. 2A to FIG. 2D.

When the user pushes the power source button 5a so as to supply electricity to the information display device 1 and pushes the menu button 5b, the information display device 1 reads the titles of the plurality of electronic books whose document files are stored in the memory card 8 and displays the title list 2a for every 10 titles on the nonvolatile display part 2. Here, at positions corresponding to the respective 10 selection buttons 6 (6c to 6l), the titles of the respective document files are displayed. Further, at a left lower edge of the display area of the nonvolatile display part 2, page position information 2b is displayed. In the page position information 2b, the total number of pages of the title list 2a displayed corresponding to the plurality of electronic books stored in the memory card 8 and the page position of the title list 2a displayed on the nonvolatile display part 2 are displayed. For example, in the page position information 2b shown in FIG. 2A, out of the title list 2a whose total number of pages is 10, the title list 2a on the first page is displayed on the nonvolatile display part 2.

Assume a case where the user cannot find the document file of the electronic book which the user wants to read in a state where the title list 2a on the first page is displayed on the nonvolatile display part 2. When the user pushes the next-page turning button 5f, as shown in FIG. 2B, the title list 2a on the second page is displayed on the nonvolatile display part 2. Here, there may be a case where the user wants to return to the previous title list 2a. In such a case, when the user pushes the previous-page turning button 5g, the title list 2a on the first page is displayed again on the nonvolatile display part 2.

Next, assume a case where the user pushes the selection button 6h corresponding to the title “Tortoise-shell cat story” of the document file which the user wants to read, for example, in a state where the title list 2a on the second page shown in FIG. 2B is displayed on the nonvolatile display part 2. As shown in FIG. 2C, the page data 2d on the first page of “Tortoise-shell cat story” is displayed on the nonvolatile display part 2. In this case, on the nonvolatile display part 2, the first page of “Tortoise-shell cat story” having the total pages of 356 is displayed as page position information 2b.

When the user finishes reading of the page data 2d on the first page and pushes the next-page turning button 5f, as shown in FIG. 2D, the page data 2d on the second page of “Tortoise-shell cat story” is displayed on the nonvolatile display part 2. Here, when the user wants to read again the page data 2d on the first page and pushes the previous-page turning button 5g, the page data 2d on the first page of “Tortoise-shell cat story” is displayed again on the nonvolatile display part 2.

In this manner, in the information display device 1, by operating various buttons out of the operation buttons 4 mounted on the information display device 1, the user can select the document file of an arbitrary electronic book which he wants to read from the document files corresponding to the plurality of electronic books stored in the memory card 8 and, at the same time, can sequentially read the page data on the selected document file.

The zoom-out button 5c and the zoom-in button 5d are provided for arbitrarily changing, for example, a size of characters of the page data displayed on the nonvolatile display part 2 in predetermined stages (for example, three stages) so that the user can easily read the page data.

Further, the information display device 1 uses the rechargeable battery 7 as the power source. During the use of the information display device 1, as shown in FIG. 2A to FIG. 2D, remaining battery capacity information 2c which indicates a remaining battery capacity of the battery 7 is displayed at a right lower edge of the nonvolatile display part 2.

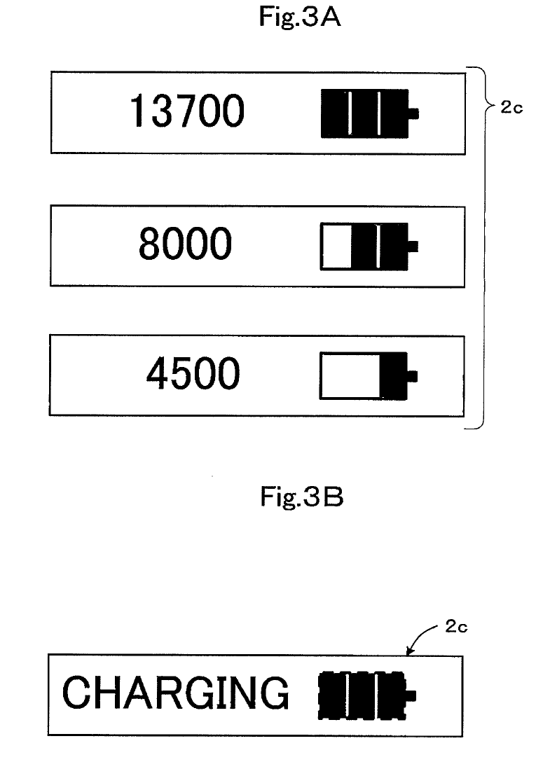

Hereinafter, a display mode of the remaining battery capacity information 2c is explained in conjunction with FIG. 2 and FIG. 3.

The information display device 1 performs a remaining battery capacity display in the same manner as a mobile phone which uses a rechargeable battery as a power source. That is, the information display device 1 displays, as shown in FIG. 3A, a battery meter which shows a schematic battery view in which three partitioned zones indicating the remaining battery capacity in three stages are formed as remaining battery capacity information 2c, and changes the number of partitioned zones to be displayed corresponding to the remaining battery capacity. Further, as shown in FIG. 3A, the information display device 1 displays, at a left side of the schematic battery view, the number of times that the rewriting processing of a display content on the nonvolatile display part 2 can be executed with a current remaining battery capacity (hereinafter referred to as rewritable number of times) as the remaining battery capacity information 2c. That is, the information display device 1 displays the number of times that the rewriting processing can be executed with the current remaining battery capacity with respect to the page data of the document file displayed on the nonvolatile display part 2 formed of an electrophoresis display panel on the nonvolatile display part 2 as the remaining battery capacity information 2c using a numeral.

When, for example, a lithium ion battery whose battery capacity after completion of charging (hereinafter referred to as fully charged battery capacity) is 1100 mAh is used as the battery 7, the rewritable number of times is calculated as follows assuming that a current consumption necessary for rewriting page data on the nonvolatile display part 2 of the information display device 1 per one-time rewriting is 300 mA, and a rewriting time is (1 second). That is, the capacity consumption necessary for rewriting page data per one-time rewriting becomes 0.08 mAh (300 mA×1 s=0.08 mAh) and hence, the rewritable number of times with the fully charged battery capacity becomes 13750 (times) (1100 mAh/0.08 mAh=13750).

Then, each time the page data on the nonvolatile display part 2 is rewritten to new page data, the rewritable number of times is set by subtracting one time from the rewritable number of times with the fully charged battery capacity (here, 13750 times).

That is, as shown in FIG. 2A, the first page of the title list 2a is displayed on the nonvolatile display part 2 and, at the same time, the rewritable number of times “13700 times” is displayed on the nonvolatile display part 2 as the remaining battery capacity information 2c. When the user pushes the next-page turning button 5f in such a state, as shown in FIG. 2B, the display content of the nonvolatile display part 2 is rewritten so that the title list 2a on the second page is displayed. Here, as the rewritable number of times to be displayed as the remaining battery capacity information 2c, “13699 times” which is the number of times obtained by subtracting one time from “13700 times” is displayed on the nonvolatile display part 2.

In the same manner, assume a case where the user pushes the next-page turning button 5f in a state where the rewritable number of times of “13698” is displayed as the remaining battery capacity information 2c as shown in FIG. 2C even during the user is reading the document file of the electronic book. In such a case, as shown in FIG. 2D, page data of the next page is displayed on the nonvolatile display part 2. Here, as the rewritable number of times to be displayed as the remaining battery capacity information 2c, “13697 times” which is the number of times obtained by subtracting one time from “13698 times” is displayed on the nonvolatile display part 2.

In this manner, when the user reads the document file of the electronic book using the information display device 1, the information display device 1 displays the remaining battery capacity of the battery 7 on the nonvolatile display part 2 in a form of the rewritable number of times of the display content. The rewritable number of times of the display content is, in other words, the number of pages of the page data which the user can read. Accordingly, the user can accurately know the remaining battery capacity, and the remaining battery capacity display is directly associated with the operation which the user performs himself and hence, the user can extremely easily know the remaining battery capacity. Further, for example, the user can select an electronic book whose number of pages corresponds to the remaining battery capacity. Accordingly, when the user is reading an electronic book, it is unnecessary for the user to worry about a possibility that his reading of the electronic book is interrupted due to the exhaustion of the battery.

Further, the information display device 1 performs not only the display of the rewritable number of times as the remaining battery capacity information 2c but also the remaining battery capacity display in which remaining battery capacity is displayed in three stages by displaying the battery meter having three partitioned zones. One partition zone corresponds to ⅓ of the fully-charged battery capacity (1100 mAh).

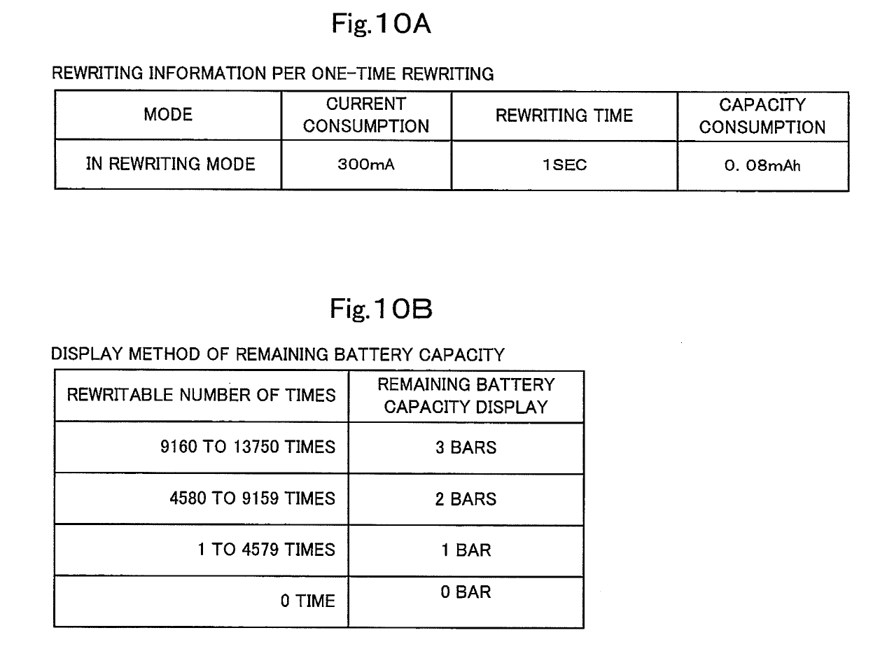

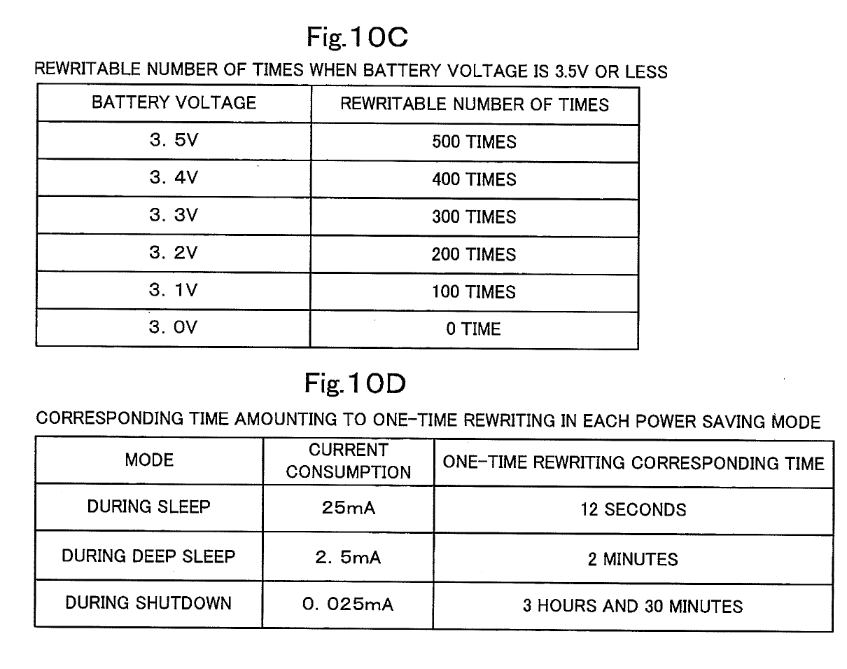

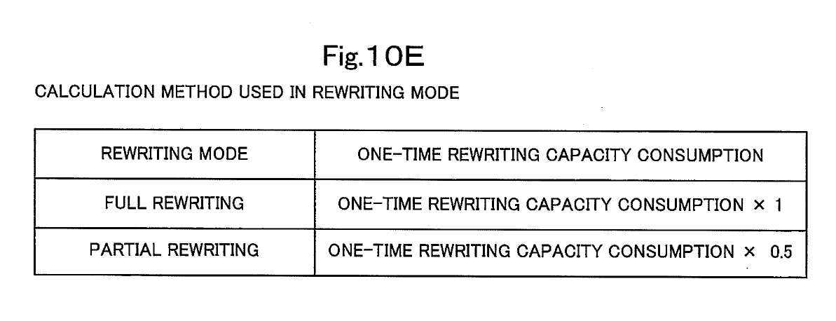

The battery meter can perform the remaining battery capacity display corresponding to the rewritable number of times. That is, for example, as shown in FIG. 10B, the remaining battery capacity display of the battery meter shows three bars when the rewritable number of times falls within a range of “9160 times to 13750 times”, and all three partitioned zones of the battery meter are lit. In the remaining battery capacity display of the battery meter when the rewritable number of times falls within a range of “4580 times to 9159 times”, one partitioned zone on a left edge of the battery meter is extinguished so that the battery meter displays that the remaining battery capacity becomes ⅔. Further, in the remaining battery capacity display of the battery meter when the rewritable number of times falls within a range of “1 time to 4579 times”, two partitioned zones on a left edge and the center of the battery meter are extinguished so that the battery meter displays that the remaining battery capacity becomes ⅓ thus informing the user of charging timing.

When the AC adapter which constitutes an external power source is connected to the external connection terminal 18 so that electricity is supplied to the information display device 1 (FIG. 1), the power source control part 15 functions as a charging part for charging the battery 7. When the power source control part 15 functions as the charging part, in the information display device 1, as shown in FIG. 3B, the rewritable number of times to be displayed as the remaining battery capacity information 2c is replaced with characters “charging undergoing”, and all partitioned zones of the battery meter are lit and, at the same time, the surrounding of the battery meter flickers so as to display the “charging undergoing”.

An operation mode of the information display device 1 is classified into four modes consisting of a rewriting mode, a sleep mode, a deep sleep mode, and a shutdown mode. Hereinafter, a relationship between the operation mode of the information display device 1 and the remaining battery capacity is explained in conjunction with FIG. 10.

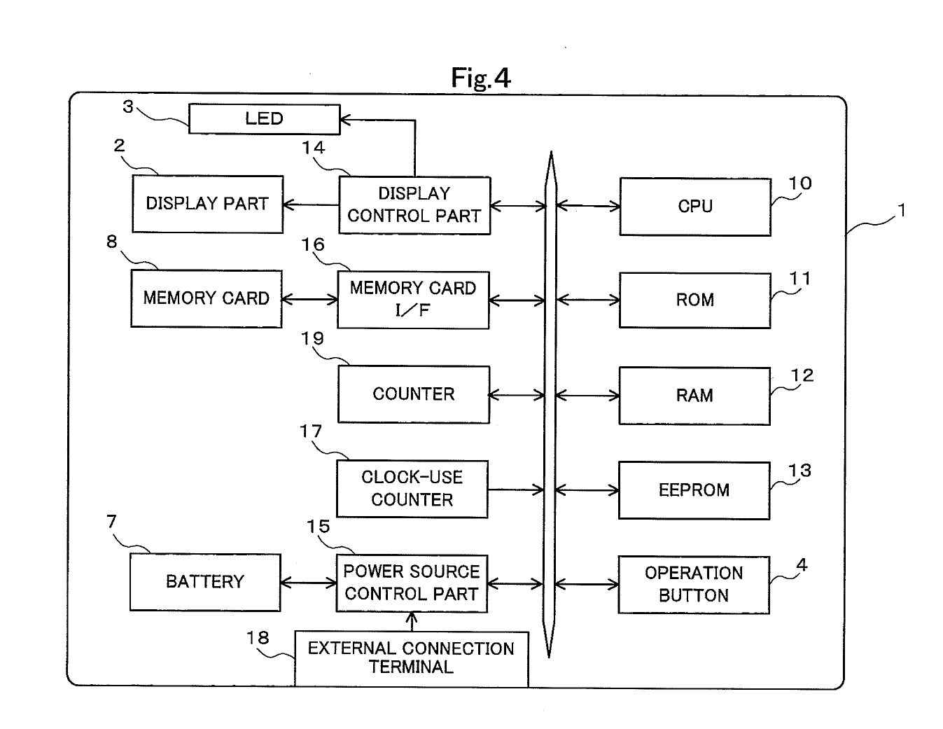

The rewriting mode is an operation mode where the page data of the document file which is displayed on the nonvolatile display part 2 is rewritten. This rewriting mode is an operation mode where the supply of electricity to peripheral devices, such as the nonvolatile display part 2, the display control part 14 and the memory card I/F 16 (see FIG. 4), and the CPU 10 is not restricted so that current consumption becomes maximum. The current consumption per one-time rewriting is 300 mA as shown in FIG. 10A.

In the above-mentioned four kinds of operation modes, only when the rewriting mode is executed, a drive signal is outputted to the nonvolatile display part 2 from the display control part 14 so that electricity is supplied to the nonvolatile display part 2. In the operation modes other than the rewriting mode, a drive signal is not outputted to the nonvolatile display part 2 from the display control part 14 so that electricity is not supplied to the nonvolatile display part 2. Particularly, in the deep sleep mode and the shutdown mode, the supply of electricity to the display control part 14 is stopped thus realizing the power saving.

The modes other than the rewriting mode, that is, the sleep mode, the deep sleep mode and the shutdown mode are power saving operation modes as shown in FIG. 10D and the current consumption differs depending on the mode.

The sleep mode is an operation mode which the information display device 1 assumes immediately after the rewriting mode is finished. In this sleep mode, the supply of electricity to the peripheral devices such as the display control part 14 and the memory card I/F 16 (see FIG. 4) is restricted thus realizing the power saving. The current consumption in this sleep mode is 25 mA as shown in FIG. 10D.

The deep sleep mode is an operation mode which the information display device 1 assumes on a condition that a predetermined time (for example, 3 seconds) elapses in a state where the information display device 1 assumes the sleep mode. In this deep sleep mode, the supply of an electric current to the peripheral devices, such as the display control part 14 and the memory card I/F 16 (see FIG. 4), and the CPU 10 is restricted thus realizing the further power saving compared to the sleep mode. The current consumption in the deep sleep mode is 2.5 mA as shown in FIG. 10D.

The shutdown mode is an operation mode which the information display device 1 assumes when the deep sleep mode continues for a predetermined time (for example, 10 minutes) or the user operates the power source button 5a. In this shutdown mode, electricity is supplied only to a clock-use counter 17 (see FIG. 4), and the supply of electricity to devices other than the clock-use counter 17, that is, the peripheral devices, such as the display control part 14 and the memory card I/F 16 (see FIG. 4), and the CPU 10 is cut. That is, the shutdown mode is the operation mode which exhibits the minimum current consumption. The current consumption of the information display device 1 in the shutdown mode is 0.025 mA as shown in FIG. 10D.

The information display device 1 functions as a rewriting-number-of-times correction part also in the power saving modes other than the rewriting mode (sleep mode, deep sleep mode and shutdown mode). That is, based on the current consumption corresponding to the processing time in each mode, the rewriting-number-of-times correction part changes the battery meter and the rewritable number of times displayed on the nonvolatile display part 2 as the remaining battery capacity information 2c.

That is, although explained in detail later, the information display device 1 includes a counter 19 which can measure an execution time of the power saving mode and the clock-use counter 17 (see FIG. 4). As shown in FIG. 10D, when the processing time in each power saving mode arrives at a predetermined time, such a processing time corresponds to the current consumption when the rewriting mode is performed one time. Accordingly, the information display device 1 accumulates current consumption corresponding to the processing time in each power saving mode, and when the accumulated current consumption corresponds to the current consumption when the rewriting mode is performed one time, the information display device 1 decreases the rewritable number of times and display the decreased rewritable number of times on the nonvolatile display part 2 as the remaining battery capacity information 2c.

### [2. Specific Constitution of Information Display Device]

Next, the constitution and the manner of operation of the above-mentioned information display device 1 is specifically explained by taking an example of the specific constitution.

### [2.1 Overall Constitution of Information Display Device]

Firstly, the electrical constitution of the information display device 1 is explained in conjunction with FIG. 4.

As shown in FIG. 4, the information display device 1 includes the nonvolatile display part 2, the LED 3, the operation buttons 4, the battery 7, the memory card 8, the CPU 10, the ROM 11, the RAM 12, the EEPROM 13, the display control part 14, the power source control part 15, the memory card I/F 16, the clock-use counter 17, the external connection terminal 18 and the counter 19.

Various information and a program which operates the information display device 1 are stored in the ROM 11. The CPU 10 functions as the control part which reads the program from the ROM 11 and executes the program and is operated as a rewriting-number-of-times counting part, the remaining battery capacity deriving part, and the rewriting-number-of-times correction part. In this manner, the CPU 1.0 performs a total control of the information display device 1.

Further, the ROM 11 functions as a memory part. As shown in FIG. 10A to FIG. 10E, the ROM 11 stores, as a data table, rewriting information per one-time rewriting (FIG. 10A), display methods of remaining battery capacity (FIG. 10B), the rewritable number of times when a battery voltage is 3.5V or less (FIG. 10C), a corresponding time amounting to one-time rewriting in each power saving mode (FIG. 10D), a calculation method used in the rewriting mode (FIG. 10E) and the like.

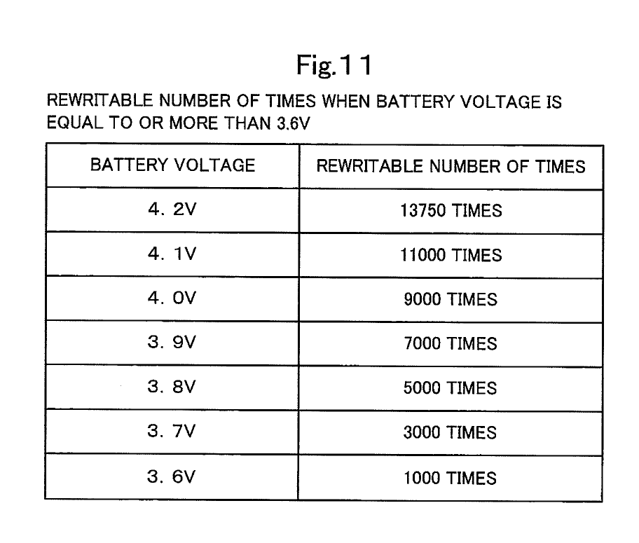

Further, as shown in FIG. 11, the ROM 11 stores the rewritable number of times when the battery voltage is 3.5V or less as a data table.

Here, in place of preliminarily storing the various information or the program in the ROM 11, the CPU 10 of the information display device 1 may take out the various information or the program from a storage medium such as the memory card 8 through the memory card I/F 16 and may store the various information or the program in the ROM 11. In this case, the various information or the program is stored in the memory card 8. A rewritable EEPROM may be used as the ROM 11.

The RAM 12 is a memory which temporarily stores various data, and is used in the control processing executed by the CPU 10.

The EEPROM 13 is a nonvolatile memory in which the above-mentioned rewritable number of times and the like are stored.

Further, the information display device 1 includes, as the operation buttons 4, various operation buttons 5a to 5g, 6a to 6m shown in FIG. 1. When the user operates the respective buttons, predetermined detection signals are supplied to the CPU 10.

The display control part 14 controls a display content displayed on the nonvolatile display part 2 and a display content displayed by the LED 3. The display control part 14 includes an FPGA for controlling a gate driver and a source driver, a power source generating part (DC-DC converter or the like) necessary for driving a display panel and the like. The gate driver and the source driver operate TFTs (Thin Film Transistors) which are used as switching elements for applying voltages to pixel electrodes of an electrophoresis display panel which constitutes the nonvolatile display part 2. The display control part 14 functions as a display processing part which performs rewriting processing of a display content to be displayed on the nonvolatile display part 2. Further, the display control part 14 functions as a remaining battery capacity display processing part which performs display processing of information on remaining battery capacity.

The information display device 1 is driven using electricity supplied from the battery 7 when electricity is not supplied from the AC adopter which constitutes an external power source. When the AC adapter or the like is connected to the external connection terminal 18 so that electricity is supplied to the information display device 1 from the AC adapter, the information display device 1 is controlled by the power source control part 15 such that the information display device 1 is driven with electricity supplied from the AC adapter.

The power source control part 15, when the information display device 1 is driven with electricity supplied from the battery 7, functions as a battery voltage detection part which detects a voltage of the battery 7. When the AC adapter is connected to the external connection terminal 18 so that electricity is supplied to the information display device 1 from the AC adapter, the power source control part 15 functions as the charging part which charges the battery 7 and the charging completion detection part which detects the completion of charging of the battery 7.

Further, document files of a plurality of electronic books are stored in the memory card 8. The memory card I/F 16 reads page data contained in the document file in the electronic book from the memory card 8 and controls writing of page data in the memory card 8. The CPU 10 performs a control where information such as a title and page data of a document file of the electronic book is read from the memory card 8 by controlling the memory card I/F 16, and the read information is displayed on the nonvolatile display part 2.

The counter 19 is constituted of a plurality of counters consisting of a counter 1 and a counter 2 described later which differ in a count time. The counter 19 counts predetermined times in accordance with a start instruction of the CPU 10. The counter 19 functions as a counting part which counts a time during which rewriting processing is not executed.

The clock-use counter 17 is provided for measuring a present time in the information display device 1, and predetermined electricity is always supplied to the clock-use counter 17.

### [2.2 Specific Operation of Information Display Device 1]

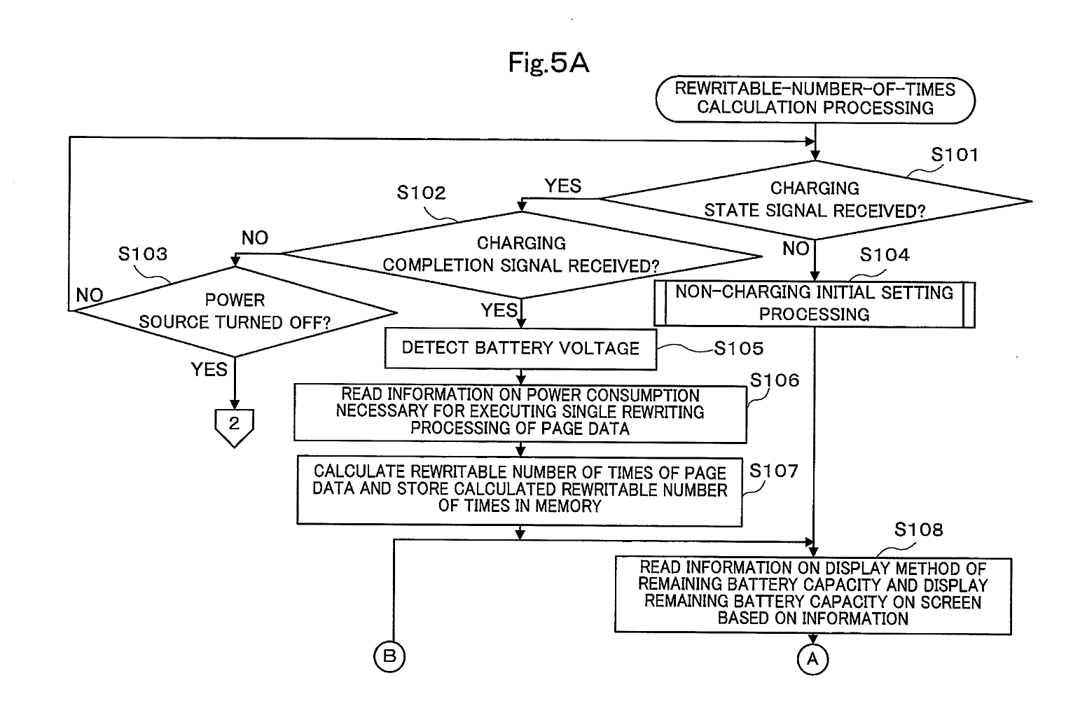

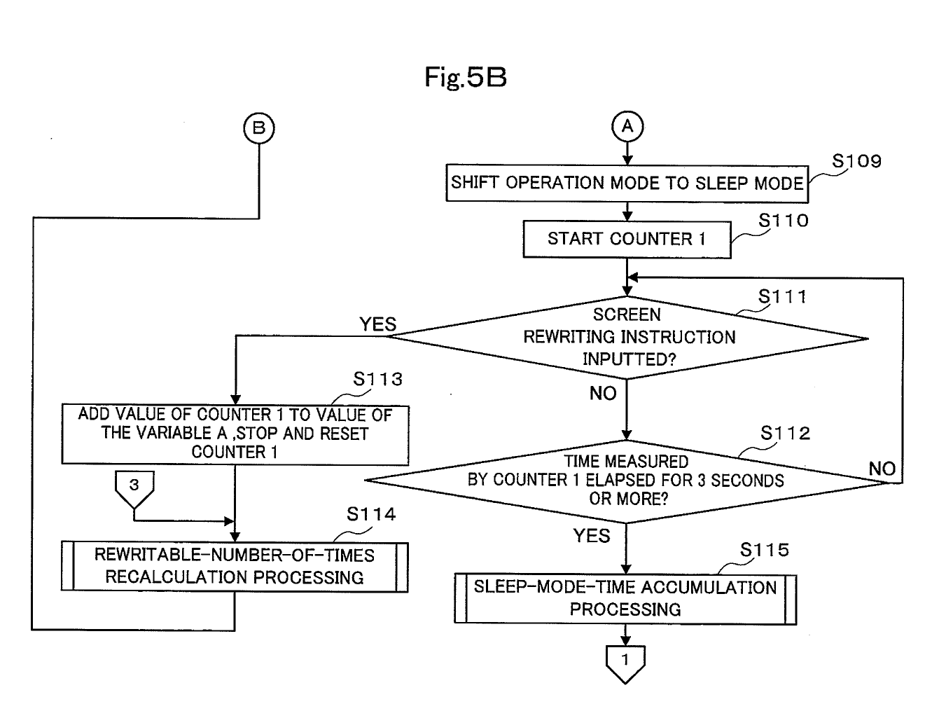

Next, the rewritable-number-of-times calculation processing in the information display device 1 according to this embodiment is explained in conjunction with FIG. 5A to FIG. 8. The CPU 10 which executes rewritable-number-of-times calculation processing functions as the rewriting-number-of-times counting part, the remaining battery capacity deriving part and the rewriting-number-of-times correction part.

Hereinafter, the explanation is made mainly with respect to the processing which displays the remaining battery capacity of the battery 7 by converting the remaining battery capacity of the battery 7 into the rewritable number of times. The rewritable-number-of-times calculation processing is processing which is executed when the information display device 1 starts its operation with the supply of electricity from the battery 7 incorporated into the information display device 1 but not from an AC adapter. Further, assume that electricity is already supplied to the information display device 1 by the user so that the CPU 10 is in an operating state.

Further, regions where values of the variables A to E described later are stored are formed in the EEPROM 13. The CPU 10, for determining an elapsed time in various modes, changes the values of the variables A to E stored in the EEPROM 13. After the rewritable-number-of-times calculation processing and before the processing in step S101 is executed, the values of the variables A to E are cleared by the CPU 10 (that is, “0”). The value of the variable A is a value of an elapsed time in the sleep mode until the elapsed time in the sleep mode becomes 3 seconds. The value of the variable B is a value of the elapsed time in the sleep mode until the elapsed time in the sleep mode becomes 12 seconds. The value of the variable C is a value of an elapsed time in the deep sleep mode until the elapsed time in the deep sleep mode becomes 2 minutes. The value of the variable D is a value of time during which the information display device is operated in the deep sleep mode without being shifted to other modes. The value of the variable E is a value for calculating the value of the variable D.

The CPU 10 of the information display device 1, firstly, determines whether or not a charging state signal is received (step S101). When the CPU 10 of the information display device 1 determines that the charging state signal is not received (step S101: NO), the CPU 10 advances the processing to step S104. On the other hand, when the CPU 10 of the information display device 1 determines that the charging state signal is received (step S101: YES), the CPU 10 advances the processing to step S102. The charging state signal whose presence/non-presence is determined in step S101 is a signal transmitted to the CPU 10 from the power source control part 15 (FIG. 4) when the AC adapter is connected to the external connection terminal 18 and electricity is supplied to the external connection terminal 18 from the AC adapter. That is, when the information display device 1 is driven by the AC adapter which constitutes the external power source, the rewritable-number-of-times calculation processing is not performed in the information display device 1.

In step S102, the CPU 10 determines whether or not a charging completion signal is received. When the CPU 10 determines that the charging completion signal is not received (step S102: NO), the CPU 10 advances the processing to step S103. On the other hand, when the CPU 10 determines that the charging completion signal is received (step S102: YES), the CPU 10 advances the processing to step S105. The charging completion signal whose presence/non-presence is determined in step S102 is a signal which is transmitted to the CPU 10 from the power source control part 15 (FIG. 4) when the battery 7 assumes a fully charged state so that the information display device 1 is operable. That is, when the AC adapter is connected to the external connection terminal 18 so that electricity is supplied to the external connection terminal 18 from the AC adapter, the power source control part 15 starts charging of the battery 7. Thereafter, when the battery capacity of the battery 7 reaches a predetermined battery capacity (for example, 1100 mAh), the power source control part 15 stops charging of the battery 7, and transmits a signal indicative of stopping of charging of the CPU 10. This signal is the charging completion signal.

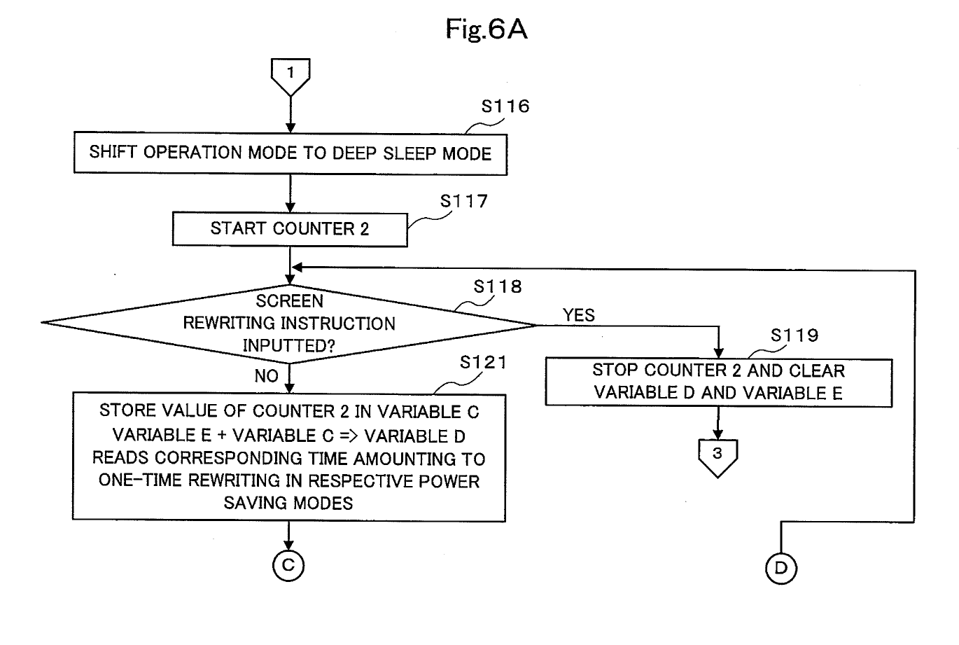

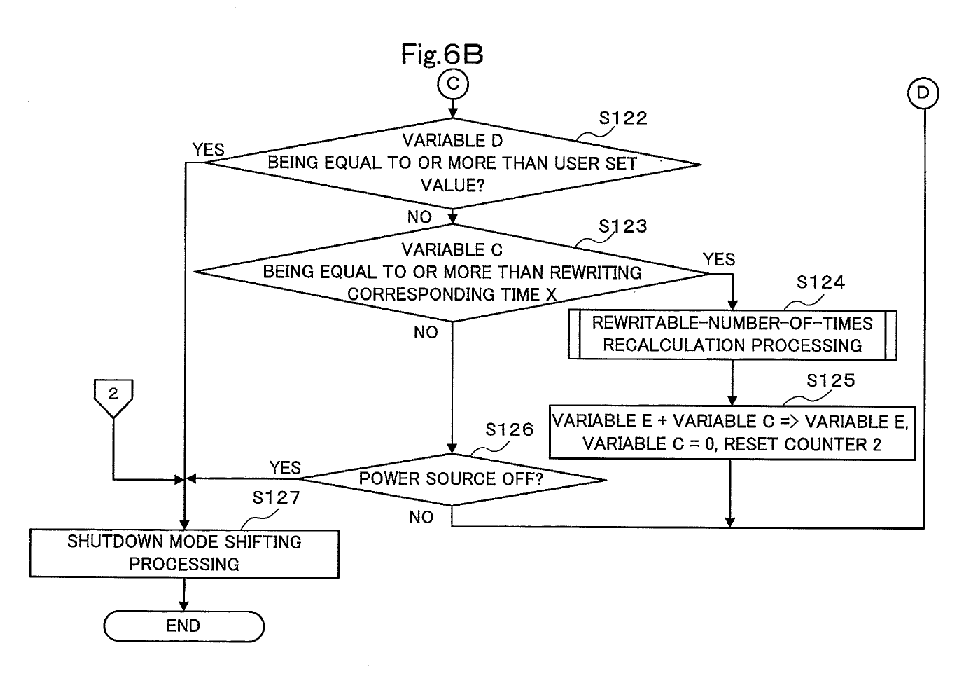

In step S103, the CPU 10 determines whether or not a power source button 5a is operated by the user. When the CPU 10 determines that the power source button 5a is operated (step S103: YES), the CPU 10 advances the processing to step S127 (FIG. 6). On the other hand, when the CPU 10 determines that the power source button 5a is not operated (step S103: NO), the CPU 10 advances the processing to step S101.

In step S104, the CPU 10 executes non-charging initial setting processing. Although the detail of the processing is explained later, in the non-charging initial setting processing, the CPU 10 measures a time during which the information display device 1 is in a shutdown mode, accumulates power consumption of the battery 7 when the information display device 1 is in the shutdown mode, and converts the remaining battery capacity of the battery 7 into the rewritable number of times based on the accumulated power consumption. The CPU 10 also executes processing which decides the rewritable number of times corresponding to a voltage of the battery 7. When the non-charging initial setting processing is finished, the CPU 10 advances the processing to step S108.

When the CPU 10 determines that the charging completion signal is received (step S102: YES), the CPU 10 allows the power source control part 15 to detect a voltage of the battery 7 (step S105), and stores a detected value in a predetermined area of an EEPROM 13. Next, the CPU 10 reads information on power consumption which is necessary for executing single rewriting processing of page data displayed on the nonvolatile display part 2 of the information display device 1 (FIG. 10A) (step S106).

Then, in step S107, based on a full capacity of the battery 7 (1100 mAh) and the information on power consumption necessary for executing single rewriting processing (rewriting information) (FIG. 10A) which is read in the previous processing, the CPU 10 calculates the rewritable number of times of page data at a point of time that the charging of the battery 7 is completed, and stores the calculated rewritable number of times of page data in a predetermined area of the EEPROM 13. When this processing is finished, the CPU 10 advances the processing to step S108.

The rewritable number of times at a point of time that the charging of the battery 7 is completed which is calculated in step S107 is specifically calculated by the following arithmetic operation. That is, the fully charged battery capacity of the battery 7 (here, 1100 mAh)/one-time rewriting capacity consumption (here, 0.08 mAh)=13750 (times). 13750 times is obtained by calculating using the CPU 10 as the rewritable number of times at a point of time that the charging of the battery 7 is completed, and is stored in the predetermined area of the EEPROM 13.

In the processing in step S108 which is executed after the processing in step S104 or step S107, the CPU 10 reads information on the rewritable number of times which is stored in the predetermined area of the EEPROM 13 and information on a method of displaying a remaining battery capacity using the battery meter corresponding to the rewritable number of times (see FIG. 10B), and performs a display of the remaining battery capacity based on the read result. That is, information on the read remaining battery capacity display using the battery meter and information on the rewritable number of times are outputted to the display control part 14 from the CPU 10 so that the battery meter and the rewritable number of times are displayed on the nonvolatile display part 2 as the remaining battery capacity information 2c (see FIG. 2).

As shown in FIG. 5B, in step S109, the CPU 10 shifts the operation mode of the information display device 1 to the sleep mode. As described previously, the operation mode of the information display device 1 is constituted of four kinds of modes, that is, the rewriting mode, the sleep mode, the deep sleep mode and the shutdown mode. Among these operation modes, the operation mode is shifted to the sleep mode which is a power saving mode (see FIG. 10D).

In step S110, the CPU 10 instructs the counter 1 to start a counting operation. That is, the CPU 10, for measuring an elapsed time in the sleep mode, allows the counter 1 which is one of the above-mentioned plurality of counters which differ in count time (counter 19 (see FIG. 4)) to count the elapsed time by a prescribed time unit (for example, 0.1 second).

In step S111, the CPU 10 determines whether or not a screen rewriting instruction is inputted to the CPU 10. When the CPU 10 determines that the screen rewriting instruction is inputted (step S111: YES), the CPU 10 advances the processing to step S113. On the other hand, when the CPU 10 determines that the screen rewriting instruction is not inputted (step S111: NO), the CPU 10 advances the processing to step S112. In step S112, the CPU 10 determines whether or not the time measured by the counter 1 elapses for 3 seconds or more. When the CPU 10 determines that the time measured by the counter 1 elapses for 3 seconds or more (step S112: YES), the CPU 10 advances the processing to step S115. On the other hand, when the CPU 10 determines that the time measured by the counter 1 does not elapse for 3 seconds or more (step S112: NO), the CPU 10 returns the processing to step S111.

In the processing in step S111 and step S112, the CPU 10 measures the elapsed time in the sleep mode until the elapsed time reaches a predetermined time (that is, 3 seconds or more) by the counter 1. The CPU 10 monitors inputting of the instruction for rewriting page data to be displayed on the nonvolatile display part 2 during this measurement. Inputting of the instruction for rewriting page data means inputting of the screen rewriting instruction. That is, the instruction for rewriting the page data is inputted when the user operates the menu button 5b, the zoom-out button 5c, the zoom-in button 5d, the next-page turning button 5f or the previous-page turning button 5g of the information display device 1.

In step S113, the CPU 10 reads a value of the variable A stored in the predetermined area of the EEPROM 13, and stores a value obtained by adding a value of the counter 1 to the value of the variable A in the predetermined area of the EEPROM 13 as the value of the variable A. Further, the CPU 10 instructs the counter 1 to stop counting and to perform resetting. That is, when the screen rewriting instruction is inputted to the CPU 10, the operation mode of the information display device 1 is shifted from the sleep mode to the rewriting mode and hence, the CPU 10 stores the elapsed time in the sleep mode, and stops the counter 1.

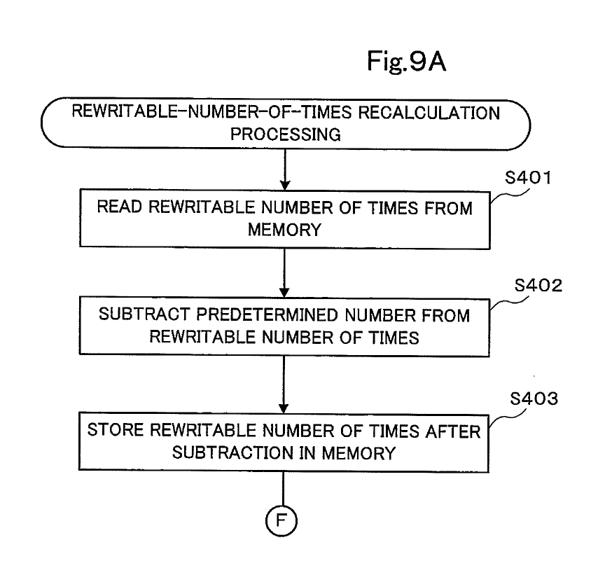

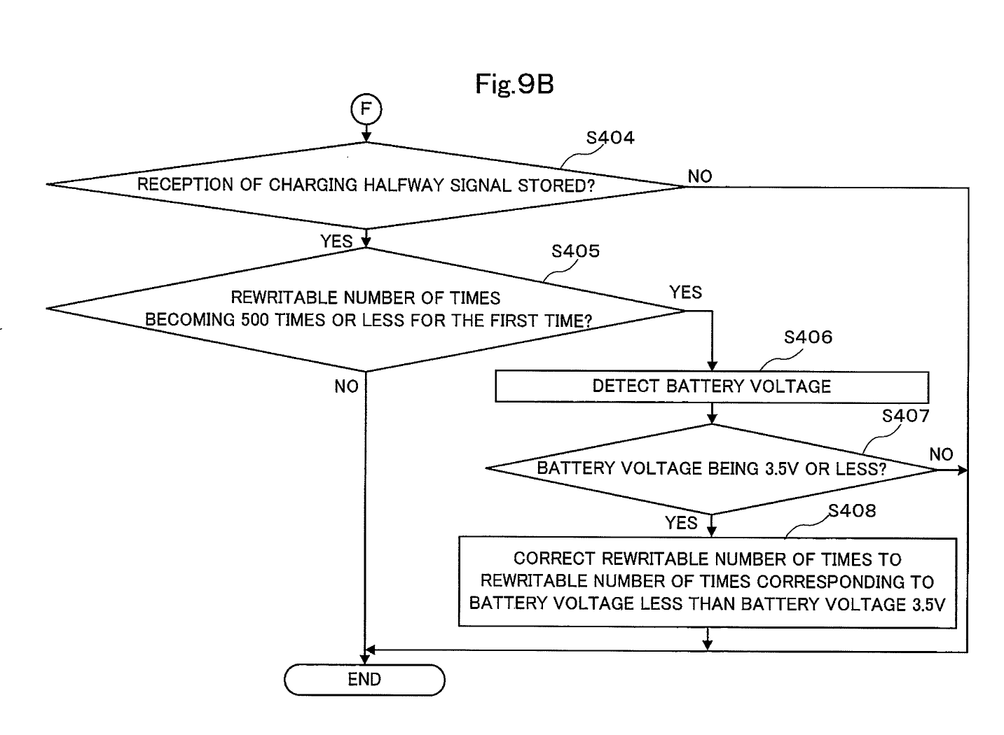

Then, in step S114, the CPU 10 executes rewritable-number-of-times recalculation processing (see FIG. 9). Although the explanation is made in detail later, in the rewritable-number-of-times recalculation processing, the CPU 10 decreases the rewritable number of times stored in the predetermined area of the EEPROM 13 and, at the same time, when this rewritable-number-of-times recalculation processing is executed before charging of the battery 7 is completed, there may be a case where the rewritable number of times is corrected corresponding to a voltage of the battery 7. When this processing is finished, the CPU 10 advances the processing to step S108.

In the above-mentioned processing in step S114, the CPU 10 sets the number of subtractions from the rewritable number of times corresponding to a rate of page data rewritten by the nonvolatile display part 2. To be more specific, as shown in FIG. 10E, when a rate of page data rewritten by the nonvolatile display part 2 which is stored in the memory card 8 corresponds to the whole display region of the nonvolatile display part 2, the CPU 10 sets “×1” (100%) for one-time rewriting capacity consumption. When the rate of page data rewritten by the nonvolatile display part 2 corresponds to a part of the display area of the nonvolatile display part 2, the CPU 10 sets “×0.5” (50%) for one-time rewriting capacity consumption. That is, the number of subtractions of “1 time” is set in case of full rewriting and the number of subtractions of “0.5 times” is set in case of the partial rewriting. In this embodiment, “one-time rewriting capacity consumption×1” at the time of “full rewriting” shown in FIG. 10E corresponds to first power consumption information, and “one-time rewriting capacity consumption×0.5” at the time of “partial rewriting” shown in FIG. 10E corresponds to second power consumption information. The number of subtractions of “1 time” in the “full rewriting” or the number of subtractions of “0.5 times” in the “partial rewriting” set here is subtracted from the rewritable number of times stored in the predetermined area of the EEPROM 13 in the rewritable-number-of-times recalculation processing (see FIG. 9).

In step S115, the CPU 10 executes sleep-mode-time accumulation processing. Although this processing is described in detail later, in this sleep-mode-time accumulation processing, the CPU 10 accumulates an elapsed time in a sleep mode. When power consumption corresponding to the accumulated elapsed time in the sleep mode reaches the power consumption necessary for executing one-time rewriting processing of the page data displayed on the nonvolatile display part 2 of the information display device 1, the CPU 10 executes processing which decreases the rewritable number of times stored in the predetermined area of the EEPROM 13, that is, the rewritable number of times is decreased by 1. When this processing is finished, the CPU 10 advances the processing to step S116.

As shown in FIG. 6A, in step S116, the CPU 10 shifts the operation mode of the information display device 1 to the deep sleep mode. In this processing, out of the above-mentioned power saving modes, the CPU 10 shifts the operation mode of the information display device 1 to the deep sleep mode which exhibits smaller power consumption than the sleep mode. When the sleep mode continues for 3 seconds in a state where inputting of a screen rewriting instruction is not detected, the operation mode of the information display device 1 is automatically shifted to the deep sleep mode.

In step S117, the CPU 10 instructs the counter 2 to start a counting operation. That is, in this processing, the CPU 10, for measuring an elapsed time in the deep sleep mode, allows the counter 2 which is one of the above-mentioned plurality of counters which differ in count time (counter 19 (see FIG. 4)) to count the elapsed time in a deep sleep mode by a prescribed time unit (for example, 1 second).

In step S118, the CPU 10 determines whether or not the screen rewriting instruction is inputted to the CPU 10. When the CPU 10 determines that the screen rewriting instruction is inputted (step S118: YES), the CPU 10 advances the processing to step S119. On the other hand, when the CPU 10 determines that the screen rewriting instruction is not inputted (step S118: NO), the CPU 10 advances the processing to step S121.

In the processing in step S118, the CPU 10 monitors inputting of the screen rewriting instruction in the deep sleep mode. The screen rewriting instruction is inputted when the user operates any one of the menu button 5b, the zoom-out button 5c, the zoom-in button 5d, the next-page turning button 5f and the previous-page turning button 5g of the information display device 1.

When the CPU 10 determines that the screen rewriting instruction is inputted (step S118: YES), the CPU 10 instructs the counter 2 to stop the counting operation (step S119). That is, when the screen rewriting instruction is inputted, the operation mode of the information display device 1 is shifted from the deep sleep mode to the rewriting mode and hence, the CPU 10 stops the counting operation of the counter 2. Further, the CPU 10 clears the value of the valuable D and the value of the variable E stored in the predetermined area of the EEPROM 13 (that is, sets these values to “0”). When this processing is finished, the CPU 10 advances the processing to step S114, and executes the rewritable-number-of-times recalculation processing in the same manner as the above-mentioned case where the screen rewriting instruction is inputted in the sleep mode.

On the other hand, in the processing in step S121 which is executed when the CPU 10 determines that the screen rewriting instruction is not inputted (step S118: NO), the CPU 10 stores the time measured by the counter 2 in the predetermined area of the EEPROM 13 as the value of the variable C. Further, the CPU 10 reads the value of the variable E from the predetermined area of the EEPROM 13, adds the value of the variable C to the value of the variable E, and stores the added value in the predetermined area of the EEPROM 13 as the value of the variable D. The CPU 10 reads a corresponding time (that is, 2 minutes) amounting to one-time rewriting in the deep sleep mode from information on corresponding times amounting to one-time rewriting in respective power saving modes (see FIG. 10D), and advances the processing to step S122.

In step S122, the CPU 10 reads the value of the variable D from the predetermined area of the EEPROM 13, and determines whether or not the value of the variable D is equal to or more than a user set value (step S122). In a state where a value of 10 minutes is set as the user set value, for example, the CPU 10 determines that the value of the variable D becomes equal to or more than the user set value when the information display device 1 is continuously operated in the deep sleeve mode for 10 minutes or more without being shifted to other modes. Then, when the CPU 10 determines that the value of the variable D is equal to or more than the user set value (step S122: YES), the CPU 10 advances the processing to step S127. On the other hand, when the CPU 10 determines that the value of the variable D is less than the user set value (step S122: NO), the CPU 10 advances the processing to step S123. In this processing, the above-mentioned user set value in the processing in step S122 monitored by the CPU 10 is a time which is necessary for automatically shifting the operation mode of the information display device 1 to a shutdown mode. Although the user set value in step S122 can be set to an arbitrary time by the user, when time setting is not performed by the user, for example, a time which is set as a reference time (for example, 10 minutes) is referenced.

In step S123, the CPU 10 reads the value of the variable C stored in the predetermined area of the EEPROM 13 in the processing executed in the above-mentioned step S121, and determines whether or not the value of the variable C becomes equal to or more than a value of a corresponding time amounting to one-time rewriting in a deep sleep mode (hereinafter referred to as “rewriting corresponding time X”). Here, the rewriting corresponding time X is 2 minutes. The CPU 10 determines that the value of the variable C becomes equal to or more than the rewriting corresponding time X when the elapsed time in the deep sleep mode becomes 2 minutes (step S123). When the CPU 10 determines that the value of the variable C becomes equal to or more than the value of the rewriting corresponding time X or more (step S123: YES), the CPU 10 advances the processing to step S124. On the other hand, when the CPU 10 determines that the value of the variable C becomes less than the value of the rewriting corresponding time X (step S123: NO), the CPU 10 advances the processing to step S126.

In step S124, the CPU 10 sets the number of subtractions from the rewritable number of times stored in the predetermined area of the EEPROM 13 to “one time”, and executes the rewritable-number-of-times recalculation processing (see FIG. 9). When this processing is finished, the CPU 10 advances the processing to step S125. The CPU 10 which executes the rewritable-number-of-times recalculation processing in step S124 corresponds to the rewriting-number-of-times correction part which counts a time during which rewriting processing is not executed, and corrects the rewritable number of times by converting the time into the rewritable number of times of one time.

In step S125, the CPU 10 reads the value of the variable C and the value of the variable E stored in the predetermined region of the EEPROM 13, and the CPU 10 adds the value of the variable E to the value of the variable C. The CPU 10 stores the added value of the value of the variable C and the value of the variable E in the predetermined area of the EEPROM 13 as the value of the variable E. Thereafter, the CPU 10 clears the value of the variable C stored in the predetermined area of the EEPROM 13 (that is, sets the value of the variable C to “0”). Further, the CPU 10 resets the counter 2 (that is, sets the counter 2 to “0”).

In step S126, the CPU 10 determines whether or not the power source button 5a is operated by the user. When the CPU 10 determines that the power source button 5a is operated (step S126: YES), the CPU 10 advances the processing to step S127. On the other hand, when the CPU 10 determines that the power source button 5a is not operated (step S126: NO), the CPU 10 advances the processing to step S118.

In step S127, the CPU 10 executes the shutdown mode shifting processing. In this shutdown mode shifting processing, the CPU 10 stores a present time read from the clock-use counter 17, and the finishing of the execution of the shutdown mode shifting processing in the predetermined area of the EEPROM 13. Further, the CPU 10 clears the value of the variable D stored in the predetermined area of the EEPROM 13 (that is, sets the value of the variable D to “0”), instructs the counter 1 and the counter 2 to stop the counting operation, and finishes the rewritable-number-of-times calculation processing.

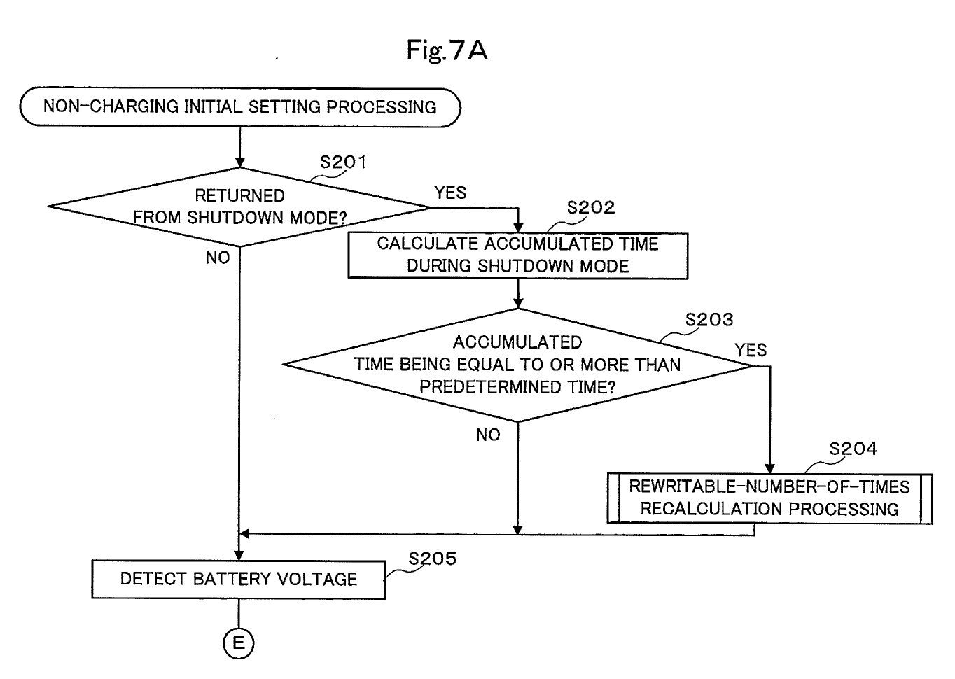

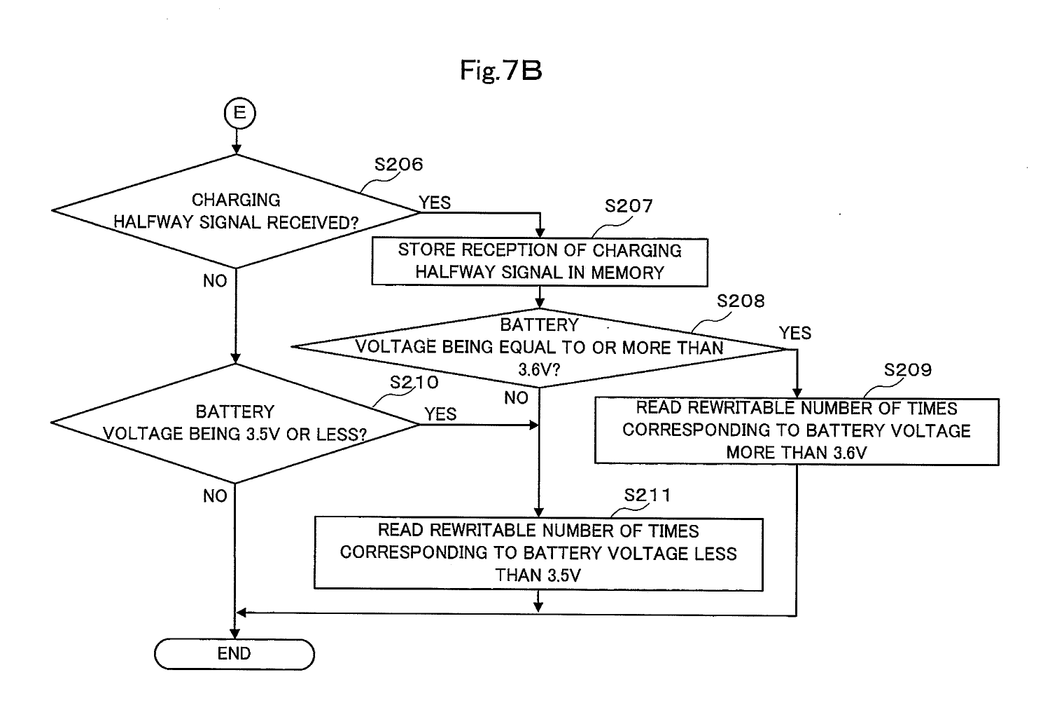

Next, non-charging initial setting processing executed in step S104 during the rewritable-number-of-times calculation processing is explained in conjunction with FIG. 7A and FIG. 7B.

Firstly, as shown in FIG. 7A, in step S201, the CPU 10 determines whether or not the processing returns from a shutdown mode by referencing the execution of the shutdown mode shifting processing stored in the predetermined area of the EEPROM in the above-mentioned shutdown mode shifting processing (rewritable-number-of-times calculation processing, step S127). When the CPU 10 determines that the processing returns to the rewritable number calculation processing from the shutdown mode (step S201: YES), the CPU 10 advances the processing to step S202. On the other hand, when the CPU 10 determines that there is no return from the shutdown mode (step S201: NO), the CPU 10 advances the processing to step S205.

In step S202, the CPU 10 reads a present time from the clock-use counter 17. Then, the CPU 10 calculates an elapsed time in the shutdown mode based on the present time and the time stored in the predetermined area of the EEPROM 13 in the shutdown mode shifting processing, and adds the elapsed time to an accumulated time of the shutdown mode stored in the predetermined area of the EEPROM 13, and stores the accumulated time added with the elapsed time.

In step S203, the CPU 10 reads one-time rewriting corresponding time (here, 3 hours and 30 minutes) at the shutdown time based on information on corresponding times amounting to one-time rewriting in the respective power saving modes (see FIG. 10D). The CPU 10 compares the one-time rewriting corresponding time read in this manner with the accumulated time of the shutdown mode calculated in step S202, and determines whether or not the accumulated time is equal to or more than the one-time rewriting corresponding time at the shutdown time. When the CPU 10 determines that the accumulated time is equal to or more than the one-time rewriting corresponding time (step S203: YES), the CPU 10 advances the processing to step S204. On the other hand, when the CPU 10 determines that the accumulated time is not more than the one-time rewriting corresponding time (step S203: NO), the CPU 10 advances the processing to step S205.

In step S204, the CPU 10 executes the rewritable-number-of-times recalculation processing (see FIG. 9). In this processing in step S204, the CPU 10 determines the number of one-time rewriting corresponding times which correspond to the accumulated time of the shutdown mode calculated in step S202.

To be more specific, for example, assuming that the accumulated time of the shutdown mode is “8 hours”, the CPU 10 determines that the accumulated time is a time which is 2 times or more as long as the one-time rewriting corresponding time in the shutdown mode which is “3 hours and 30 minutes” (see FIG. 10D). 2 times which is obtained by such determination is set as the number of subtractions, and the rewritable-number-of-times recalculation processing described later (see FIG. 9) is executed based on the number of subtractions.

Further, in step S204, the CPU 10 stores a value obtained by subtracting the one-time rewriting corresponding time during the shutdown mode amounting to the number of subtractions from the accumulated time of the shutdown mode calculated in step S202 in the predetermined area of the EEPROM 13 as a new accumulated time of the shutdown mode. When this processing is finished, the CPU 10 advances the processing to step S205.

The CPU 10 which executes the rewritable-number-of-times recalculation processing in step S204, in the same manner as the execution of the rewritable-number-of-times recalculation processing in step S124, corresponds to a rewriting-number-of-times correction part which counts a time during which the rewriting processing is not executed, and corrects the rewritable number of times by converting the time into one-time rewritable number of times.

In step S205, the CPU 10 detects a battery voltage of the battery 7 from the power source control part 15. In step S206, the CPU 10 determines whether or not a charging halfway signal is received from the power source control part 15. When the CPU 10 determines that the charging halfway signal is not received (step S206: NO), the CPU 10 advances the processing to step S210. On the other hand, when the CPU 10 of the information display device 1 determines that the charging halfway signal is received (step S206: YES), the CPU 10 advances the processing to step S207.

As shown in FIG. 7B, the charging halfway signal whose presence/non-presence is determined in step S206 is a signal transmitted to the CPU 10 from the power source control part 15 when the power source control part 15 (see FIG. 4) controls charging of the battery 7 due to the supply of electricity to the power source control part 15 from the external power source, and charging is interrupted before a charging completion signal which indicates the completion of charging of the battery 7 is received.

In step S207, the CPU 10 stores the reception of the charging halfway signal in step S206 in a predetermined area of the EEPROM 13.

In step S208, the CPU 10 determines whether or not the battery voltage detected in step S205 is equal to or more than a predetermined voltage (that is, 3.6V). When the CPU 10 determines that the battery voltage is equal to or more than the predetermined voltage (step S208: YES), the CPU 10 advances the processing to step S209. On the other hand, when the CPU 10 determines that the battery voltage is less than the predetermined voltage (step S208: NO), the CPU 10 advances the processing to step S211.

In step S209, the CPU 10 references information on the rewritable number of times when the battery voltage is equal to or more than 3.6V (see FIG. 11), decides the rewritable number of times corresponding to the detected battery voltage, and stores the rewritable number of times in the predetermined area of the EEPROM 13. Then, the CPU 10 finishes the non-charging initial setting processing.

That is, in the processing in steps S206 to S209, when charging is interrupted before the charging completion signal which indicates the completion of charging of the battery 7 is received, on a condition that the present battery voltage of the battery 7 is equal to or more than 3.6V, the CPU 10 decides the rewritable number of times based on the information on the rewritable number of times when the battery voltage shown in FIG. 11 is equal to or more than 3.6V.

In step S210, the CPU 10 determines whether or not the battery voltage detected in step S205 is equal to or less than a predetermined voltage (that is, 3.5V). When the CPU 10 determines that the battery voltage is equal to or less than the predetermined voltage (step S210: YES), the CPU 10 advances the processing to step S211. On the other hand, when the CPU 10 determines that the battery voltage is not equal to or less than the predetermined voltage (step S210: NO), the CPU 10 finishes the non-charging initial setting processing.

In step S211, the CPU 10 references information on the rewritable number of times when the battery voltage is 3.5V or less (see FIG. 10C), decides the rewritable number of times corresponding to the detected battery voltage, and stores the rewritable number of times in the predetermined area of the EEPROM 13. Then, the CPU 10 finishes the non-charging initial setting processing.

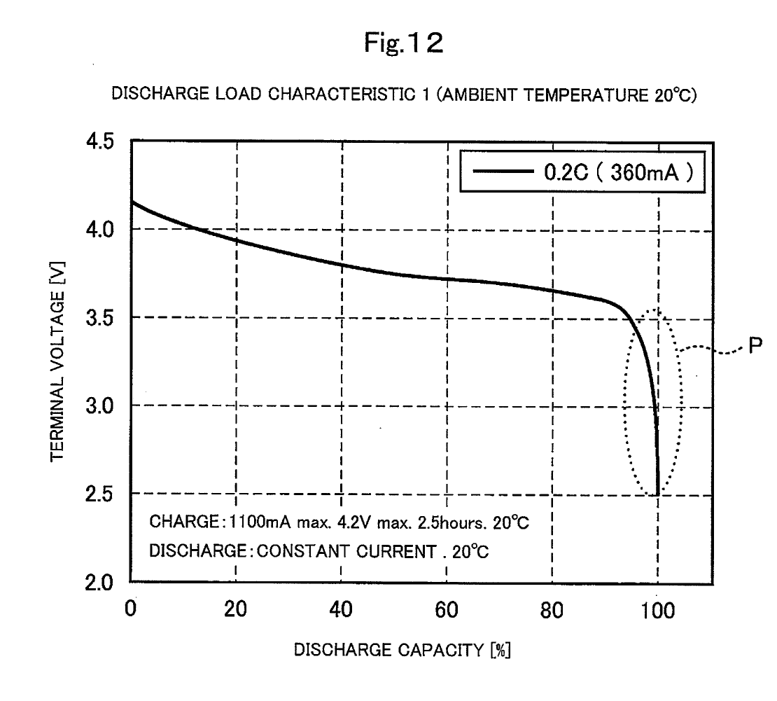

The processing in step S207 is provided by taking the discharge load characteristic of the lithium ion battery used as the battery 7 into consideration. As shown in FIG. 12, as the discharge load characteristic of the lithium ion battery, the discharge load characteristic is extremely accelerated in an area P where the battery voltage is 3.5V or less. As a result, there is a possibility that an error occurs between the rewritable number of times calculated in the rewritable-number-of-times calculation processing (see FIG. 5, FIG. 6) and the rewritable number of times corresponding to the actual remaining battery capacity. Accordingly, on the condition that the battery voltage of the battery 7 becomes 3.5V or less, the rewritable number of times is decided based on the information on the rewritable number of times when the battery voltage is 3.5V or less (predetermined remaining battery capacity information, see FIG. 10C).

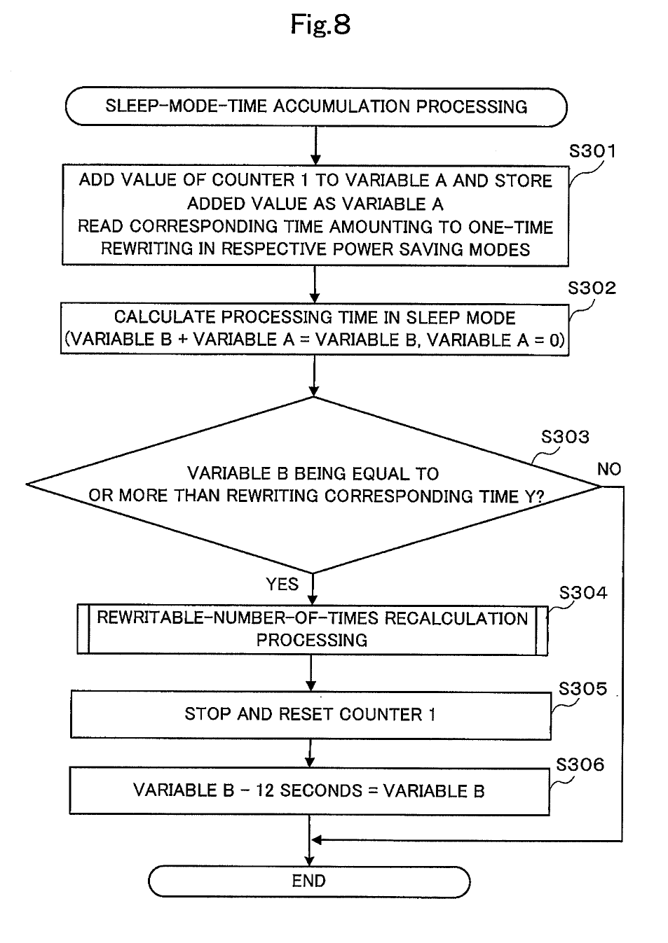

Here, the sleep-mode-time accumulation processing executed in step S115 for rewritable-number-of-times calculation processing is explained in conjunction with FIG. 8.

Firstly, in step S301, the CPU 10 adds the variable A stored in the predetermined area of the EEPROM 13 to the value of the counter 1 (that is, 3 seconds), and stores the combined value in the predetermined area of the EEPROM 13. Then, the CPU 10 reads the one-time rewriting corresponding time (that is, 12 seconds) in the sleep mode based on the information on the corresponding time amounting to one-time rewriting in each power saving mode (FIG. 10D).

In step S302, the CPU 10 calculates the elapsed time in the sleep mode. That is, the CPU 10 adds the value of the variable A calculated in step S301 and the value of the variable B stored in the predetermined area of the EEPROM 13, and stores the added value in the predetermined area of the EEPROM 13 as the value of the elapsed time, that is, as the value of the variable B in a new sleep mode. Further, the CPU 10 clears the value of the variable A stored in the predetermined area of the EEPROM 13 (that is, sets the value of the variable A to “0”).

Then, in step S303, the CPU 10 determines whether or not the value of the variable B becomes equal to or more than a value of a corresponding time amounting to one-time rewriting in a sleep mode (hereinafter referred to as “rewriting corresponding time Y”). Here, the rewriting corresponding time Y is 12 seconds. When the elapsed time in the deep sleep mode becomes 12 seconds, the CPU 10 determines that the value of the variable B becomes equal to or more than the rewriting corresponding time Y (step S303). When the CPU 10 determines that the value of the variable B is less than the value of the rewriting corresponding time Y (step S303:NO), the CPU 10 finishes the sleep mode time accumulation processing. On the other hand, when the CPU 10 determines that the value of the variable B is equal to or more than the rewriting corresponding time Y (step S303:YES), the CPU 10 advances the processing to step S304. In step S304, the CPU 10 executes the rewritable-number-of-times recalculation processing.

In step S304, the CPU 10 sets the number of subtractions from the rewritable number of times stored in the predetermined area of the EEPROM 13 to “1 time”, and executes the rewritable-number-of-times recalculation processing (see FIG. 9). When this processing is finished, the CPU 10 advances the processing to step S305.

The CPU 10 which executes the rewritable-number-of-times recalculation processing in step S304 corresponds to the rewriting-number-of-times correction part which, in the same manner as the rewritable-number-of-times recalculation processing executed in the above-mentioned step S124 and step S204, counts a time during which the rewriting processing is not performed, and corrects the rewritable number of times by converting the time into the one-time rewritable number of times.

In step S305, the CPU 10 stops and resets the counter 1 (that is, setting the counter value to “0”). Then, in step S306, the CPU 10 stores a value obtained by subtracting one rewriting corresponding time (that is, 12 seconds) in the sleep mode from the elapsed time in the sleep mode in the predetermined area of the EEPROM 13 as the elapsed time in the new sleep mode. When this processing is finished, the CPU 10 finishes the sleep-mode-time accumulation processing.

Finally, the rewritable-number-of-times recalculation processing which is executed in step S114 and step S124 for the rewritable-number-of-times calculation processing (FIG. 5 or FIG. 6), in step S204 for the non-charging initial setting processing (FIG. 7), and in step S304 for sleep-mode-time accumulation processing (FIG. 8) is explained in conjunction with FIG. 9.

Firstly, as shown in FIG. 9A, the CPU 10 reads the rewritable number of times stored in the predetermined area of the EEPROM 13 in step S401, and subtracts the set subtracting number of times from the rewritable number of times in step S402. Then, the CPU 10 stores the rewritable number of times after subtraction in the predetermined area of the EEPROM 13 in step S403.

Then, as shown in FIG. 9B, in step S404, the CPU 10 determines whether or not the reception of the charging halfway signal is stored in the predetermined area of the EEPROM 13. When the CPU 10 determines that the charging halfway signal is not received (step S404: NO), the rewritable-number-of-times recalculation processing is finished. On the other hand, when the CPU 10 determines that the charging halfway signal is received (step S404: YES), the CPU 10 advances the processing to step S405.

In step S405, the CPU 10 determines whether or not the calculated rewritable number of times becomes 500 times or less in the processing for the first time in the above-mentioned steps S401 to S403. When the CPU 10 determines that the calculated rewritable number of times becomes 500 times or less for the first time (step S405: YES), the CPU 10 advances the processing to step S406. On the other hand, when the CPU 10 determines that the calculated rewritable number of times is not 500 times or less (step S405: NO), the rewritable-number-of-times recalculation processing is finished.

In step S406, the CPU 10 detects a battery voltage of the battery 7 from the power source control part 15. In step S407, the CPU 10 determines whether or not the battery voltage detected in the above-mentioned step S406 is equal to or less than a predetermined voltage (that is, 3.5V). When the CPU 10 determines that the battery voltage is equal to or less than the predetermined voltage (step S407: YES), the CPU 10 advances the processing to step S408. On the other hand, when the CPU 10 determines that the battery voltage is not equal to or less than the predetermined voltage (step S407: NO), the CPU 10 finishes the rewritable-number-of-times recalculation processing.

In step S408, the CPU 10 references information on the rewritable number of times when the battery voltage is 3.5V or less (see FIG. 10C), decides the rewritable number of times corresponding to the detected battery voltage, and stores the rewritable number of times in the predetermined area of the EEPROM 13. Then, the CPU 10 finishes the rewritable-number-of-times recalculation processing.

The processing in step S408 is executed on a condition that when the information display device 1 is used in a state where charging of the battery 7 is interrupted halfway (that is, in a state where the charging halfway signal is received), the rewritable number of times becomes 500 times or less for the first time and, at the same time, the potential voltage is 3.5V or less. In the processing in step S408, the CPU 10 performs the correction of the rewritable number of times based on information on the rewritable number of times when the battery voltage is 3.5V or less (predetermined remaining battery capacity information, see FIG. 10C) thus performing a more accurate remaining battery capacity display.

According to the above-mentioned embodiment, the user knows a remaining battery capacity more accurately due to the remaining battery capacity display displayed on the nonvolatile display part 2. Accordingly, even when the user carries and uses the information display device 1 outdoors or the like where the battery 7 cannot be charged, the user accurately knows the time at which reading of an electronic book or the like is interrupted due to exhaustion of the battery 7. Further, the user can charge the battery 7 at proper timing.

Further, in this embodiment, also in a state where the rewriting processing is not executed, that is, in an operation mode such as the sleep mode, the deep sleep mode or the shutdown mode, the current consumption corresponding to an elapsed time in each operation mode is calculated, and when the current consumption calculated in each operation mode is equal to or more than one-time rewriting current consumption, the rewritable number of times is subtracted thus realizing an accurate remaining battery capacity display. However, the present invention is not limited to such a remaining battery capacity display control. For example, the current consumptions of the respective operation modes are summed, and when the summed current consumption becomes equal to or more than the one-time rewritable current consumption, the rewritable number of times is decreased thus realizing an accurate remaining battery capacity display with a small error.

In the above-mentioned embodiment, as shown in FIG. 3A, the remaining battery capacity of the battery 7 is displayed in a state where the battery meter which imitates a pattern of the battery and the rewritable number of times are simultaneously displayed as the remaining battery capacity information. However, the present invention is not limited to such a remaining battery capacity display. For example, only the battery meter may be displayed or only the rewritable number of times may be displayed. Further, the user can arbitrarily select the display of remaining battery capacity information.

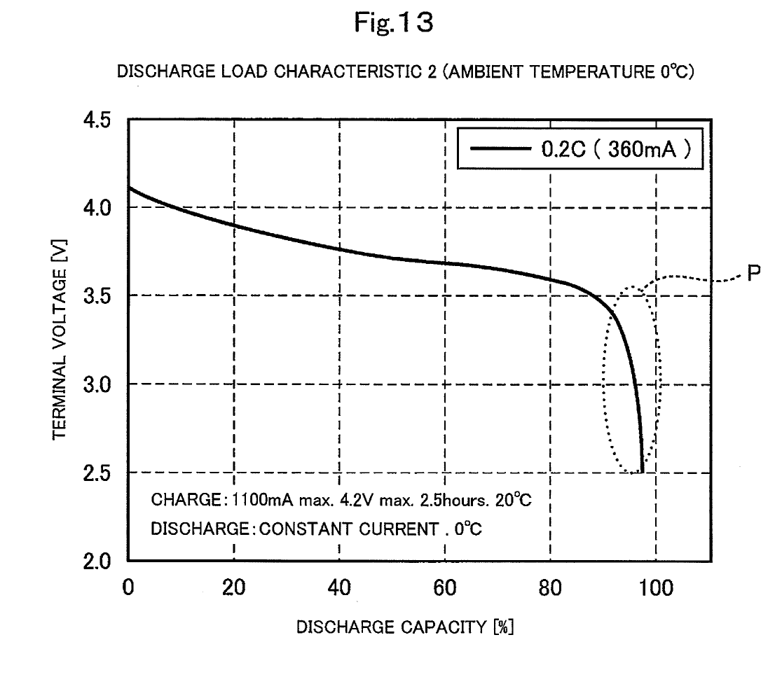

Further, in this embodiment, using the discharge load characteristic where an ambient temperature of the battery 7 is assumed to be 20° C. (see FIG. 12), the predetermined voltage which extremely accelerates the discharge load characteristic is set to 3.5V. However, a lithium ion battery which is used as the battery 7 changes a discharge load characteristic thereof depending on an ambient temperature. Accordingly, the information display device 1 may include a thermometer for detecting the ambient temperature of the battery 7, and for example, when the ambient temperature is 0° C., it is possible to decide the predetermined voltage which extremely accelerates the discharge load characteristic in conformity with the discharge load characteristic when the ambient temperature of the battery 7 shown in FIG. 13 is 0° C. That is, a plurality of discharge load characteristics corresponding to ambient temperatures of the battery 7 are stored, and the predetermined voltage which extremely accelerates the discharge load characteristic can be decided based on the discharge load characteristic corresponding to the ambient temperature of the battery 7 when the information display device 1 is used.

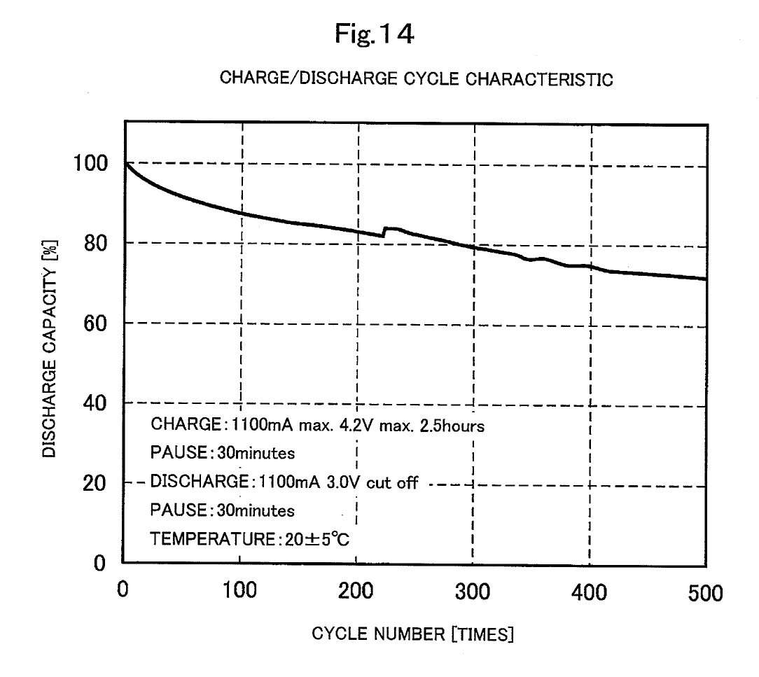

In this embodiment, the rewritable number of times is calculated assuming that the fully charged battery capacity of the battery 7 is fixed (for example, 1100 mAh) when the charging is completed. However, in a case where a lithium ion battery is used as the battery 7, as shown in FIG. 14, according to a charge/discharge cycle characteristic of the lithium ion battery, when charge/discharge is performed approximately 300 times, the charging capacity is lowered by approximately 20% compared to a fresh battery. Accordingly, in general, the charge/discharge of 300 times is set as a use limit of the lithium ion battery in most cases. Accordingly, by taking the charge/discharge cycle characteristic of the lithium ion battery into consideration, for example, the rewritable number of times may be calculated such that the number of times of full charging of the battery 7 is counted, and the charging capacity is decreased by 2% for every 30 times. Further, by counting the number of times of full charging of the battery 7, it may be possible to display a message or the like which prompts a user to exchange the battery on the nonvolatile display part 2 at a point of time that the number of times of full charging reaches 300 times.

Further, in this embodiment, the rewritable number of times is calculated with respect to the battery capacity at the time of completion of charging assuming that the information display device 1 is used in a state where the completion of charging of the battery 7 is detected. However, it is not always the case that the battery 7 is charged to a level of the completion of charging every time, and there may be a case that the battery 7 is used as a power source in the midst of charging. Accordingly, even in a case where the supply of electricity from the external power source is interrupted in a state that charging is not yet completed, when a lithium ion battery is used as the battery 7, an elapsed charging time and a battery voltage of the battery 7 are measured, the battery capacity of the battery 7 is derived based on the measured values while taking the charging characteristic of the lithium ion battery (not shown in the drawing) into consideration, and the rewritable number of times corresponding to the derived battery capacity is calculated thus realizing the accurate remaining battery capacity display corresponding to the rewritable number of times.

In the above-mentioned embodiment, the explanation has been made with respect to the case where the lithium ion battery is used as the battery 7. However, the battery 7 is not limited to the lithium ion battery. As the rechargeable secondary battery, a Ni—Cd battery, a nickel-hydrogen battery or the like may be used. In this case, by calculating the rewritable number of times corresponding to the discharge load characteristic, the charge/discharge cycle characteristic and the charging characteristic of the used secondary battery, the remaining battery capacity display can be accurately displayed.

Although several embodiments of the present invention have been explained in detail in conjunction with drawings, they are provided only for an illustration purpose. The present invention can be exercised in other forms to which various modification and improvements are applied based on knowledge of those who are skilled in the art.

What is claimed is:

1. An information display device comprising:
a nonvolatile display part which is configured to maintain a display even when the supply of electricity from a power source is cut;
a display processing part which is configured to execute rewriting processing of a display content displayed on the nonvolatile display part;
a charging part which is configured to charge a battery which is used as the power source;
a charging completion detection part which is configured to detect the completion of charging of the battery by the charging part;
a rewriting-number-of-times counting part which is configured to count the number of times of the rewriting processing executed by the display processing part after the completion of charging of the battery is detected by the charging completion detection part;
a remaining battery capacity deriving part which is configured to derive information on a remaining battery capacity of a battery based on the number of times of rewriting processing; and
a remaining battery capacity display processing part which is configured to execute display processing of the information on the remaining battery capacity derived by the remaining battery capacity deriving part.

2. An information display device according to claim 1, further comprising:
a battery voltage detection part which is configured to detect a voltage of the battery; and
a memory part which is configured to store a preset remaining capacity information which is preset corresponding to a voltage of a battery of a predetermined value or less in association with the voltage of the battery, wherein
the remaining battery capacity deriving part sets the preset remaining capacity information stored in the memory part as information on the remaining battery capacity when the voltage of the battery detected by the battery voltage detection part becomes a predetermined value or less.

3. An information display device according to claim 1, further comprising:
a counting part which is configured to count a time during which the rewriting processing is not executed; and
a rewriting-number-of-times correction part which is configured to convert a count value obtained by the counting part into a value which corresponds to the number of times of the rewriting processing, and to correct the number of times of the rewriting processing counted by the rewriting-number-of-times counting part based on a converted value.

4. An information display device according to claim 1, further comprising a memory part which is configured to store information on power consumption necessary for the rewriting processing, wherein
the remaining battery capacity deriving part is configured to derive information on the remaining battery capacity of the battery based on the number of times of the rewriting processing and the information on the power consumption.

5. An information display device according to claim 1, wherein the memory part is configured to store first power consumption information which is information on power consumption necessary for performing the rewriting processing of a whole display region of the nonvolatile display part, and second power consumption information which is information on power consumption necessary for performing the rewriting processing of a partial display region of the nonvolatile display part, and
the remaining battery capacity deriving part is configured to derive information on the remaining battery capacity of the battery based on a result obtained by multiplying the number of times of the rewriting processing of the whole display region and the first power consumption information, and a result obtained by multiplying the number of times of the rewriting processing of the partial display region and the second power consumption information.

6. An information display device according to claim 1, wherein the remaining battery capacity deriving part is configured to derive the number of times that the rewriting processing is allowed as information on the remaining battery capacity.
